(19) United States
(12) Patent Application Publication
(10) Pub. No.: US 2021/0314154 A1
(43) Pub. Date: Oct. 7, 2021

(54) APPARATUS AND METHOD FOR DYNAMIC SHARDING OF CONCURRENT BLOCKCHAINS

(71) Applicant: Hewlett-Packard Development Company, L.P., Spring, TX (US)

(72) Inventors: Remy Husson, Bristol (GB); Joshua Serratelli Schiffman, Bristol (GB); Thalia Laing, Bristol (GB)

(73) Assignee: Hewlett-Packard Development Company, L.P., Spring, TX (US)

(21) Appl. No.: 17/058,149

(22) PCT Filed: Oct. 17, 2018
(86) PCT No.: PCT/US2018/056383

§ 371 Date: Nov. 24, 2020

(51) Int. Cl. H04L 9/32; G06F 16/903

(52) U.S. Cl. CPC H04L 9/32; G06F 16/90335

(57) ABSTRACT

An apparatus, being a network entity of a computer network is provided. The apparatus comprises a communication module to receive and to send information on a blockchain. Moreover, the apparatus comprises a query module to obtain from a master chain of the blockchain a rule for a first shard and a second shard of the blockchain with respect to a smart contract. Furthermore, the query module is to obtain information on the smart contract from the first shard or from the second shard depending on the rule. Moreover, the query module is to output the information on the smart contract.

### BACKGROUND

Blockchains are often built and set up as independent entities, and while some protocols are being developed to allow inter-ledger communications, there is always one true state for a specific blockchain. This can be easily represented by the fact that concurrent state, or forks, are resolved by choosing one good state, selecting one fork, thanks to the consensus rules.

Nevertheless, it is possible in some use cases that different forks of the same blockchain are all valid, while representing different state and views. A simple case may, e.g., be a network split where each subnetwork continues to maintain its own fork of a previously shared blockchain.

Sharding, see: https://github.com/ethereum/wiki/wiki/Sharding-FAQ, is an existing technology which aims at subdividing a blockchain into several parts, or shards, to increase scalability. All shards are independent, which means that from a shard's point of view, every information it possesses is valid.

### BRIEF DESCRIPTION OF THE DRAWINGS

Examples will now be described, by way of non-limiting examples, with reference to the accompanying drawings, in which:

FIG. 1 illustrates an apparatus according to an example,

FIG. 2a illustrates the master chain, the first shard and the second shard,

FIG. 2b illustrates a specific example of the apparatus described with respect to FIG. 1, which represents a full node,

FIG. 2c illustrates another specific example of the apparatus described with respect to FIG. 1, which represents a light node.

FIG. 3 illustrates an apparatus according to another example, wherein the apparatus further comprise a master chain generator,

FIG. 4 illustrates an apparatus according to an example and a second network entity,

FIG. 5 illustrates a system according to an example comprising an apparatus according to an example and a second network entity, and

FIG. 6 illustrates a system according to another example comprising two apparatuses according to an example.

### DETAILED DESCRIPTION

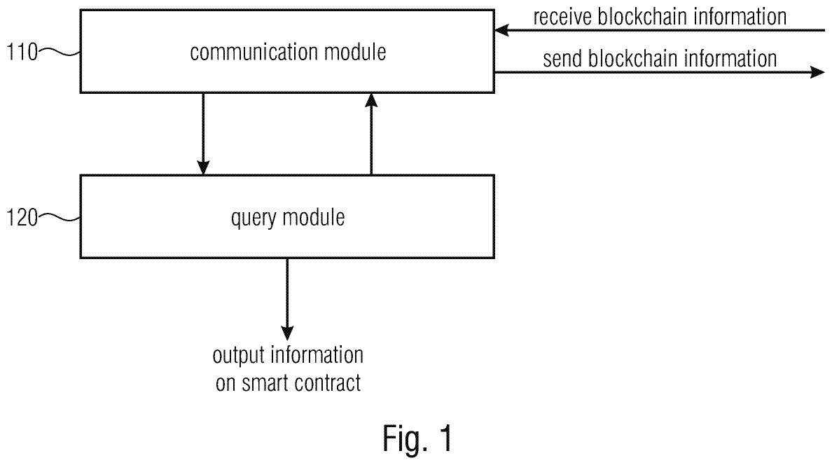

FIG. 1 illustrates an apparatus, being a network entity of a computer network.

The apparatus comprises a communication module 110 to receive and to send information on a blockchain.

Moreover, the apparatus comprises a query module 120 to obtain from a master chain of the blockchain a rule for a first shard and a second shard of the blockchain with respect to a smart contract.

Furthermore, the query module 120 is to obtain information on the smart contract from the first shard or from the second shard depending on the rule.

Moreover, the query module 120 is to output the information on the smart contract.

Similarly, a method is provided. The method comprises:

Receiving information on a blockchain.

Sending information on the blockchain.

Obtaining from a master chain of the blockchain a rule for a first shard and a second shard of the blockchain with respect to a smart contract.

Obtaining information on the smart contract from the first shard or from the second shard depending on the rule, and outputting the information on the smart contract.

Similarly, a non-transitory computer-readable medium is provided. The non-transitory computer-readable medium comprises a computer program, wherein the computer program, when executed on a computer or signal processor, causes the computer or signal processor to: Receiving information on a blockchain, sending information on the blockchain, obtaining from a master chain of the blockchain a rule for a first shard and a second shard of the blockchain with respect to a smart contract, obtaining information on the smart contract from the first shard or from the second shard depending on the rule, and outputting the information on the smart contract.

For example, a rule may, e.g., be a priority order.

In an example, the rule may, e.g., be a priority order, and the query module 120 may, e.g., be to obtain from the master chain of the blockchain the priority order. Moreover, the query module 120 may, e.g., be to obtain the information on the smart contract from the first shard or from the second shard depending on the priority order.

In an example, the query module 120 may, e.g., be to obtain from the master chain of the blockchain the priority order for the first shard, the second shard and a third shard of the blockchain with respect to the smart contract. Moreover, the query module 120 may, e.g., be to obtain information on the smart contract from the first shard or from the second shard or from the third shard depending on the priority order. Furthermore the query module 120 may, e.g., be to output the information on the smart contract.

Ordering the shards according to their priority is one way in which a conflict may, e.g., be resolved.

According to some examples, a plurality of shards of the blockchain comprises the first shard, the second shard and a third shard of the blockchain, and the rule may, e.g., be a majority decision. The query module 120 may, e.g., be to obtain from the master chain of the blockchain an indication to obtain the information with respect to the smart contract depending on the majority decision. Moreover, the query module 120 may, e.g., be to obtain the information on the smart contract from the plurality of shards of the blockchain by determining a majority of the plurality of shards that have same information with respect to the smart contract.

For example, according to an example, if two shards say event X is allowed, and a third shard says event X is not allowed, then the rule may define to go with the majority vote, rather than prioritizing one shard above the others.

In examples, more than two shards may, e.g., be considered, for example, a third shard and/or a fourth shard, etc.

If the subnetworks were to regroup, merging all of their blockchains represents a challenge as they may contain contradictory information. The challenges of resolving blockchain state conflicts after a split or a fork may, e.g., be addressed without discarding potentially valuable information. The challenge occurs when two valid versions of the same blockchain are conflicting, but a global consensus is to be reached. This is a difficult challenge and solving it for distributed environments is a new use case that has not been fully addressed in the art. Using existing techniques designed for better performance, called sharding, a protocol is described that allows every participant to reach consensus, while preserving all valid states across multiple forks. Applying blockchains and distributed ledgers in distributed and edge network environments becomes possible where forks can occur due to the transient and shifting nature of those scenarios.

In an example, the master chain of the blockchain additionally comprises rules which can be obtained from the master chain.

In an example, information from a combination of shards is queried according to rules defined in the master chain. For example, a rule in the master chain may, e.g., define to try to find information in shard1 first; if the information is not found in shard1, then try to find the information in shard2.

When two blockchains sharing concurrent states have to be merged, a master chain is created and the blockchains become shards of it. A set of rules in the master chain allows to define how transactions are relayed to the shards and which concurrent state has priority, allowing all clients to reach consensus on a global state.

This model allows to resolve conflicting states for querying and submitting while conserving all of the properties of the merged blockchains. The use of the sharding protocol allows to merge and separate blockchains at will without impacting the normal flow and rules of each chain.

For example, in a protocol:

A detection of the presence of two different forks of the same chain which are conflicting.

An agreement to set up a sharding structure and set up the rules to resolve conflicts and define future updates to the chains.

The rules are used to update and query the chains.

A possibility is provided for devices to move around shards or create new ones.

Moreover, the individual state maintained in each fork is retained. This allows for that information to be used when it is relevant for the local environment represented by the fork as defined by the conflict resolution rules.

The solution presented here tries to solve the challenge of dynamically merging and separating different forks of the same blockchain, allowing different groups to efficiently utilize the blockchain and reach global and local consensus.

The information possessed by a shard is not in any case valid for all devices and one leverages the sharded structure to allow for conflict resolution between shards.

Sharding as it was designed solved scalability, here that feature is not used but instead set up sharding to solve the challenge of forks merging.

The protocol implemented by the master chain allows sorting and resolving conflicting states between forks, while conserving the history of what happened. In a sharding protocol, shards are disjoint parts of a global blockchain whereas in another protocol shards are forks of the same chain, they are the same blockchain but in a different state.

Considering a blockchain, which state is represented by its set of smart contracts.

A smart contract can be seen as an application running on the blockchain and is defined by a code and an internal state, that will be called SmartContract (Code,State). The state of a smart contract is just a storage space assigned to it, where data can be written to or read from. Smart contracts are executed through transactions: when a client wants to call a smart contract, it will submit a transaction to the blockchain specifying which function to call along with some arguments. If successful, the transaction will result in a change of the state of the smart contract. The code of a smart contract can represent complex state machines, which will accept transactions under certain circumstances.

In case of a fork, two blockchains are created from one, meaning that all smart contracts are duplicated and will evolve differently on each fork. Regrouping different forks into a single chain is extremely challenging as different smart contracts will have different states which can be incompatible. That is why the idea is to conserve all forks and to make them run in parallel, conserving all incompatibilities. To allow the network to reach consensus on a global state, a set of rules have to be defined so that any participant can figure out which of the incompatible states is the one agreed on.

For this example, one considers two different blockchains, so one fork, but it can easily be generalized for a higher number. Considering that if both forks survived, that means that they both have a set of participants which maintains the blockchain, which may, e.g., be called validators. It doesn't matter how validators reach consensus on their fork, they just are known and trusted as a group, that is to say there are enough honest participants to ensure the integrity of the fork. It is noted that the two forks fork) and fork2 and their respective validators validator1 and validator2.

A detection mechanism may be defined so that devices realize that there are two different forks of the same chain. By looking at the smart contracts, they can figure out if the forks are conflicting or not. If the chains are not conflicting, they can decide to merge them. If they are conflicting, they can decide to set up a sharding protocol. This can be done by voting for example, or any other decision making protocol.

When the two subnetworks come together, a master chain is created. This master chain is linked to both forks using the same mechanism as sharding, which means that the master chain records the latest hash of both forks, ensuring that everybody agree on their state. Under this model, each fork becomes a shard of the main chain: fork) becomes shard), fork2 becomes shard2.

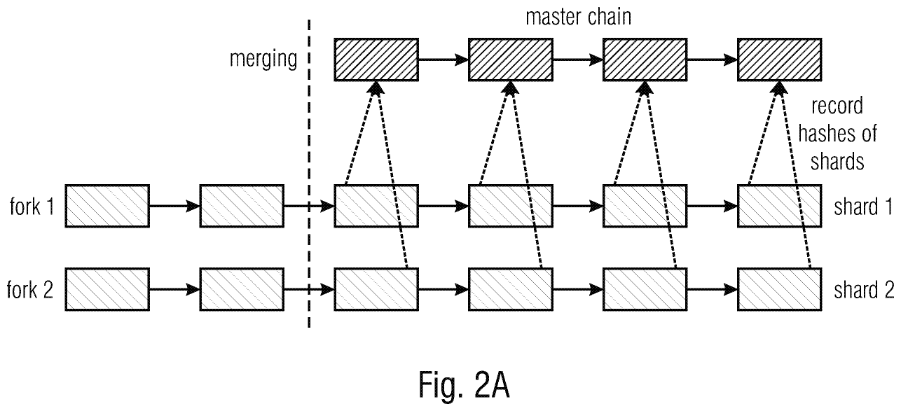

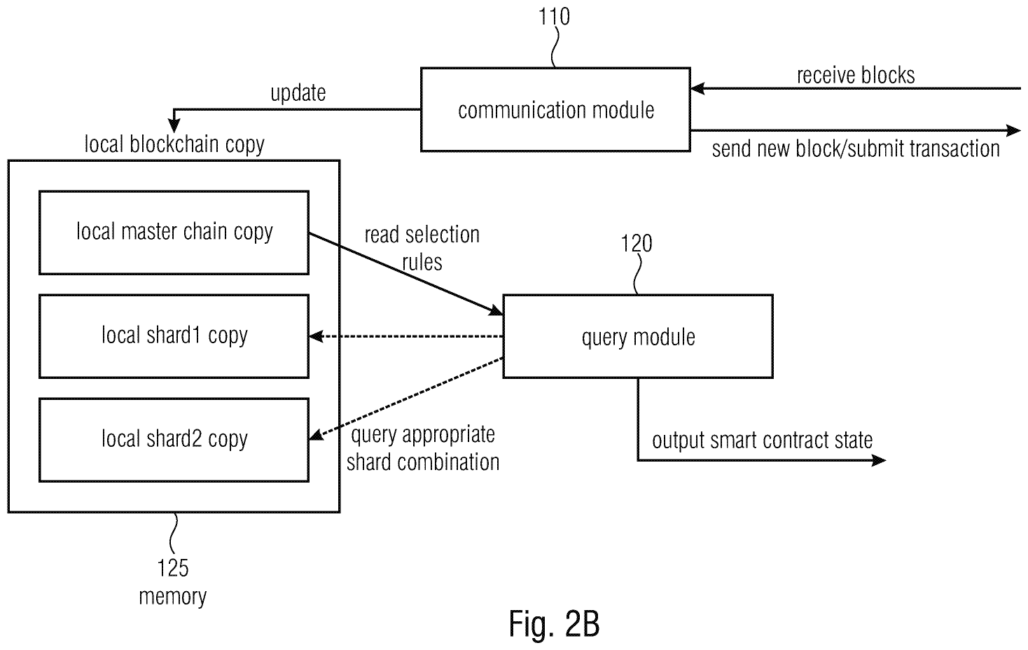

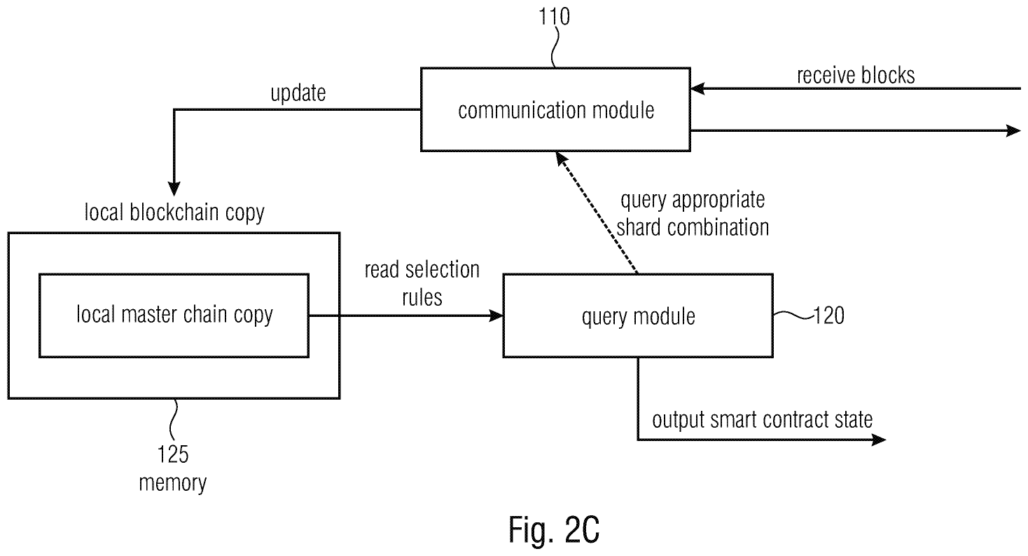

FIG. 2a illustrates the master chain, the first shard and the second shard.

The master chain is maintained by both validator1 and validator2, each fork is maintained by their respective validators. Sharding induces little overhead as maintaining the master chain is easy and because validators keep on doing the same job they were doing on their fork. It is also possible to lower the security requirements of a shard to reduce the work of the validators, by moving some characteristics to the master chain, such as block signatures if present.

To check the validity of a shard, a client just has to check the master chain and compare the latest hash recorded there against the latest hash of the corresponding shard. To allow clients to be aware that a sharding structure is in place, a field in the shards' blocks can advertise it. The master chain may, for example, merely accept blocks which sharding field is set to true, for example. This prevents an attacker from showing one shard to a device, pretending it is a fork without any master chain.

FIG. 2b illustrates a specific example of the apparatus described with respect to FIG. 1, which represents a full node. The apparatus of FIG. 2b further comprises a memory 125. Usually, e.g., in the memory 125, a node/apparatus maintains a local copy of the blockchain. Even for light nodes, which are described in FIG. 2c, the latest blocks of the blockchain would be maintained locally. In the example of FIG. 2b, the memory 125 has stored therein a local master chain copy, a local shard1 copy and a local shard2 copy.

Thus, in the example of FIG. 2b, the apparatus further comprises a memory having stored therein a local copy of the master chain and a local copy of the first shard and a local copy of the second shard.

FIG. 2c illustrates another specific example of the apparatus described with respect to FIG. 1, which represents a light node. A light node is a node which cannot store and/or process the whole blockchain. In the example of FIG. 2c, the memory 125 has stored therein a local master chain copy, but not a local shard1 copy and not a local shard2 copy.

Thus, in the example of FIG. 2c, the apparatus further comprises a memory having stored therein a local copy of the master chain but not and a local copy of the first shard and not a local copy of the second shard.

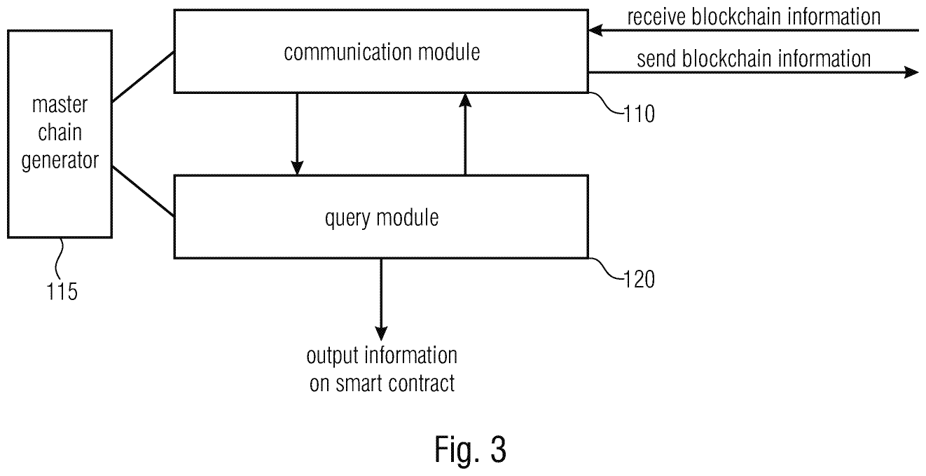

According to an example illustrated by FIG. 3, the apparatus may, e.g., further comprise a master chain generator 115 to generate the master chain of the blockchain, so that the master chain comprises for the smart contract the priority order for the first shard and the second shard of the blockchain with respect to the smart contract.

In examples, only validators need to possess the master chain generator, but not the other nodes. E.g., in a specific example, the master chain may, e.g., be maintained by a validator1 and a validator2 but no by the other nodes.

In an example, the smart contract may, e.g., be one of a plurality of smart contracts. The master chain generator 115 may, e.g., be to generate the master chain of the blockchain, so that the master chain comprises for each smart contract of the plurality of smart contracts a priority order for the first shard and the second shard of the blockchain.

In an example, when a fork is detected, an agreement may be reached to set up a sharding structure by generating and agreeing on the query and submission rules for each individual smart contract, and these rules are recorded within the master chain, with the possibility to update them over time. In examples, the nodes may then read the rules from the master chain and query the corresponding combination of shards applying the corresponding rules for the given smart contract. In examples, the possibility exists to create new shards and move around shards.

According to an example, the master chain generator 115 may, e.g., be to generate the master chain, if the master chain generator 115 detects that the first shard is different from the second shard.

In an example, the master chain generator 115 may, e.g., be to detect that the first shard is different from the second shard, if the first shard comprises a particular smart contract of the plurality of smart contracts and the second shard does not comprise the particular smart contract, or if the second shard comprises the particular smart contract of the plurality of smart contracts and the first shard does not comprise the particular smart contract.

According to an example, the master chain generator 115 may, e.g., be to detect that the first shard is different from the second shard, if first information of a considered smart contract of the plurality of smart contracts within the first shard is different from second information of the considered smart contract within the second shard.

Querying and Submitting Transactions.

The master chain has to define the rules for querying the blockchain and submitting transactions for every smart contract of both shards. All of these rules are written into the genesis block of the master chain and are to be respected by honest participants. These rules may, e.g., be separated into 3 categories:

True shared

True conflict

Split shared

Note that these are very general categories, given as example to show how the conflict resolution occurs. Depending on the use case and smart contracts in place, it is possible to define other rules and other resolutions. As the master chain can possess smart contracts of its own, complex resolution mechanisms can be built on top of the sharding structure.

In the following, the category “True shared” is considered.

The smart contract is the same for both shards, which means that from the merging this equality holds:

SmartContract_{Shard1}(Code,State)=SmartContract_{Shard2}(Code,State)

For example, 2 groups of devices are in different locations and maintain their own fork. There is a smart contract which regularly records the temperature taken by several devices. Then the 2 groups of devices meet in the same room and merge their blockchain. From now on, the states of the two smart contracts, each on its own shard, are to be the same, which means that their state is truly shared.

The rule for querying this smart contract is that the client can query any of the shards, as their state are to be shared. The rule for submitting a transaction is that the transaction is send and processed by both shards.

Now, the category “True conflict” is considered.

The smart contract has a completely different and incompatible state on both shards, which means that it is not possible to merge them in any way.

For example, a smart contract provides a service to devices which are administrators of the blockchain. Each shard will have its own administrators and won't recognize any other entity, which is representative of the case where both shards don't trust each other and don't want to merge their administrator list.

In that case every device has to associate itself with one shard. It will then query the state from its shard and submit transactions to its shard for this specific smart contract.

In the following, the category “Split shared” is considered.

The smart contract has incompatible state on each shard, but the querying structure allow to set up split shared rules. The idea is that shards are ordered, any query will go to the most priority shard, and if the query is unsuccessful the query goes to the next shard.

For example, a smart contract associates a domain name with an IP address, for example:

computer1→192168.72.56

To different networks, network1 and network2, implement this smart contract. The state of the smart contract is as follows:

network1: mycomputer→IP1

printer1→IP2

network2: computer3→IP3

printer1→IP4

If a user on network1 wants to access mycomputer, he can get its IP address by querying the smart contract. The problem arises when the two networks merge, as now there are two different devices using the same domain name printer1.

When merging, the master chain defines a priority order of the shards for this smart contract, for example: shard1>shard2. In that case, a user who queries an IP address for a given domain name will first query shard1, and queries shard2 if the query on shard1 was unsuccessful. Here are the results of the different queries:

| | Query on shard1: | Query on shard2: |
|---|---|---|
| mycomputer: | IP1 | — |
| computer 3: | No result | IP3 |
| printer1: | IP2 | — |

A query on a non-conflicting domain name still returns the right IP address, a query on a conflicting domain name is resolved with the result of the shard of higher priority.

As printer1 of network2 does not have an associated IP address anymore, it selects a new domain name, printer2 for example. To achieve that, it sends a transaction to shard1 to register the printer2 domain name. The new state becomes:

shard1: mycomputer→IP1

printer1→IP2

printer2→IP4

shard2: computer3→IP3

printer1→IP4

It can be seen here that printer2 from shard1 is the same entity than printer1 from shard2, because they have the same IP address. While the networks are merged, printer2 is the new domain name of this entity.

This solution resolves conflicts while preserving non-conflicting part of the states. Another point is that if the networks were to split, the states come back to their original status, network1 just has an unused entry printer2. If the networks merge again, the solution for the conflicts is already deployed.

When the registration of the printer2 domain name is done, an inter-shard transaction is sent, because a device from shard2 sends a transaction to shard1. For example, this transaction can be tagged so that the smart contract enforces the resulting sub-state while the sharding protocol is in place. Thus, when the networks split, the domain name printer2 is disabled for network1.

The rules for ordering shards priorities are to be defined in a smart contract metadata, and can take into account multiple parameters, such as the number of participants in each shard, geographic locations, trust levels, etc.

In an example, with respect to FIG. 1, the query module 120 may, e.g., be to determine a higher-priority shard and a lower-priority shard for the smart contract, the higher-priority shard being the shard that has a higher priority among the first shard and the second shard with respect to the smart contract, the lower-priority shard being the shard that has a lower priority among the first shard and the second shard with respect to the smart contract. Moreover, the query module 120 may, e.g., be to obtain the information on the smart contract from the higher-priority shard, if the higher-priority comprises the information on the smart contract. Furthermore, the query module 120 may, e.g., be to obtain the information on the smart contract from the lower-priority shard, if the higher-priority does not comprise the information on the smart contract.

In examples, the query module tries to derive the information from the highest priority shard with respect to the smart contract. If unsuccessful, the query module tries to derive the information from the shard with second highest priority, if unsuccessful, the query module tries to derive the information from the shard with third highest priority shard, etc.

Summarizing the Above in more General:

The master chain sets the rules for querying and updating its blockchain, and then stores this information to make it available to everyone. The rules can be part of a smart contract metadata that is enforced automatically or can be decided by the validators.

This protocol is also designed so it can be fully automated, avoiding any user interaction to handle forks in the main blockchain.

In the following, possible applications and examples are considered:

IoT, Internet of things, and edge computing environments often deal with transient devices and ad-hoc network configurations. As a result, the local state of the environment is relative to the devices present at the time it is accessed. Solutions to storing and broadcasting state in these environments such as service and directory information often rely on distributed techniques such as blockchains. Naturally occurring partitions in the network due to device transiency can create forks that are difficult to recover from.

This protocol allows for the creation of a sharded view of the environment's global state. This means that devices operating within a shard can learn about the local information and then seamlessly move to another shard without conflict. Moreover, when the disjoint group of devices reconnect, they can share their shard's information to reform the global state and thus allow for future sharding.

In the context of IoT where devices can dynamically move around, the above-described protocol can be very useful for blockchain solutions applied in that field, both for personal and business use cases. Possible applications include device management, service discovery, reputation systems, and policy management. To achieve a one life motto of bring devices from home to work to the public environment, technologies are provided that allow for the seamless and secure transition between these spaces. This sharding approach acts as the foundation for numerous solutions.

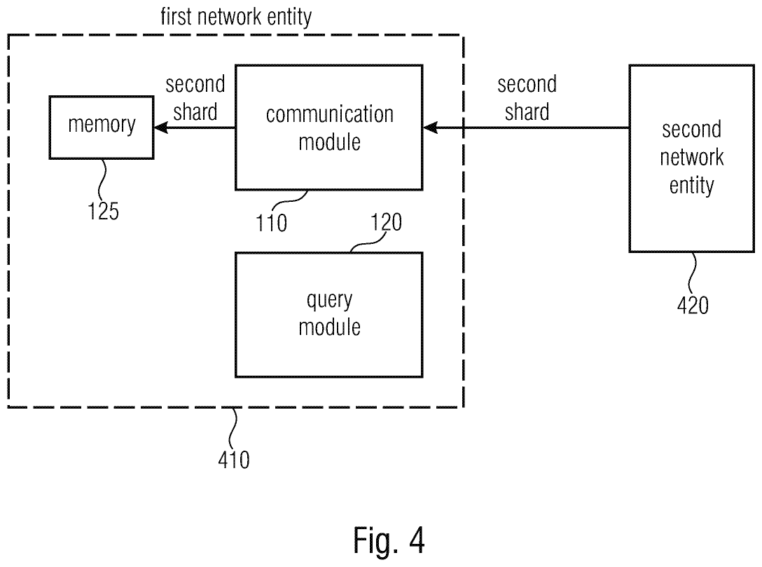

FIG. 4 illustrates an example, wherein the apparatus 410 of FIG. 1 is a first network entity. Moreover, FIG. 4 illustrates a second network entity 420. The apparatus 410 and the second network 420 entity may, e.g., be connected by the computer network. Moreover, the apparatus 410 may, e.g., comprise a memory 125 having stored thereon the first shard. The communication module 110 of the apparatus 410 may, e.g., be to receive the second shard from the second network entity 420. The apparatus 410 is to store the second shard in the memory 125. The second shard may, e.g., be considered as the information on the blockchain received by the communication module 125.

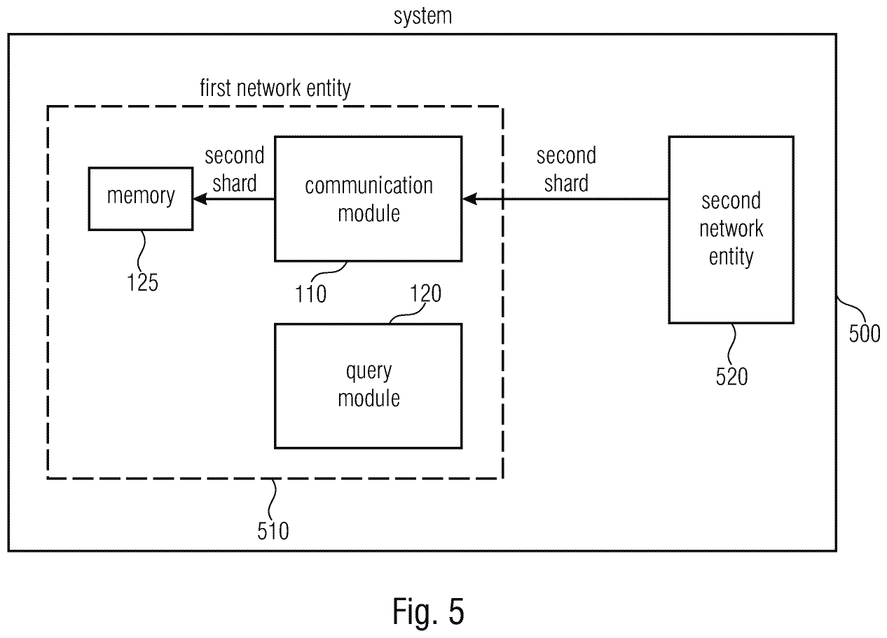

FIG. 5 illustrates a system 500 which comprises the apparatus 510 of FIG. 1 being a first network entity, and a second network entity 520. The apparatus 510 and the second network entity 520 are connected by the computer network. The apparatus 510 may e.g. comprise a memory 125 having stored thereon the first shard. The communication module 110 of the apparatus 510 may, e.g., be to receive the second shard from the second network entity. The apparatus 510 may, e.g., be to store the second shard in the memory 125.

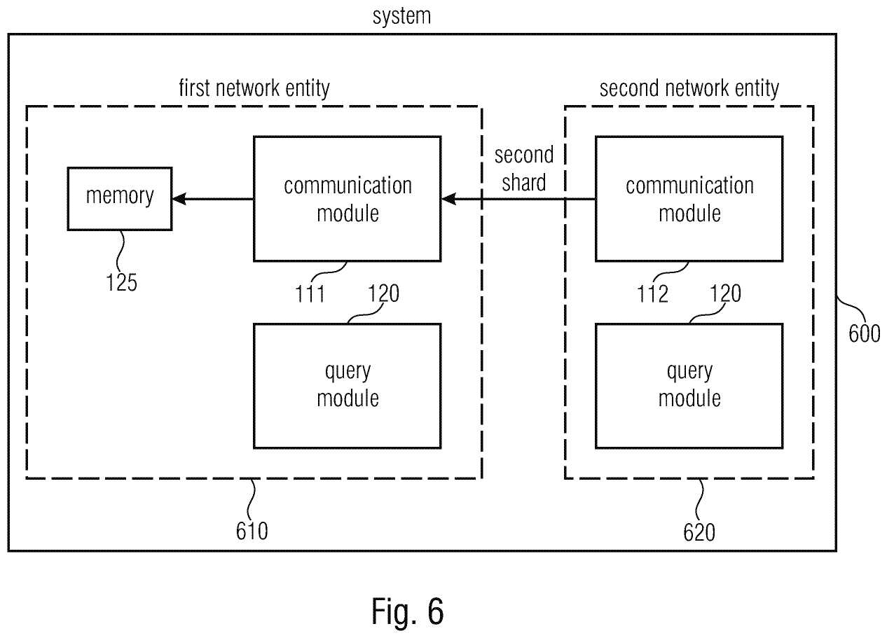

FIG. 6 illustrates a system 600 which comprises two apparatuses 610, 620 according to FIG. 1 being a first network entity 610 and a second network entity 620. The two apparatuses 610, 620 according to FIG. 1 may, e.g., be connected by the computer network. The first network entity 610 comprises a memory 125 having stored thereon the first shard. The communication module 112 of the second network entity 620 may, e.g., be to transmit the second shard to the first network entity 610. The communication module 111 of the first network entity 610 is to receive the second shard from the second network entity 620. The first network entity 610 is to store the second shard in the memory 125.

Although some aspects have been described in the context of an apparatus, it is clear that these aspects also represent a description of the corresponding method, where a block or device corresponds to a part of a method. Analogously, aspects described in the context of a part of a method also represent a description of a corresponding block or item or feature of a corresponding apparatus. All or part of a method may be executed by a hardware apparatus, for example, a microprocessor, a programmable computer or an electronic circuit. In some examples, parts of a method may be executed by such an apparatus.

Depending on certain implementation requirements, examples can be implemented in hardware or in machine-readable instructions or partially in hardware or partially in machine-readable instructions. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate with a programmable computer system such that the respective method is performed. Therefore, the digital storage medium may be computer readable.

Some examples comprise a data carrier having electronically readable control signals, which are capable of cooperating with a programmable computer system, such that one of the methods described herein is performed.

Generally, examples can be implemented as a computer program product with a program code, the program code to perform one of the methods when the computer program product runs on a computer. The program code may for example be stored on a machine readable carrier.

Other examples comprise the computer program for performing one of the methods described herein, stored on a machine readable carrier.

In other words, an example of the concept is, therefore, a computer program having a program code for performing one of the methods described herein, when the computer program runs on a computer.

A further example of the concept is, therefore, a data carrier or a digital storage medium, or a computer-readable medium, comprising, recorded thereon, the computer program for performing one of the methods described herein. The data carrier, the digital storage medium or the recorded medium may, e.g., be tangible and/or non-transitory.

A further example of the concept is, therefore, a data stream or a sequence of signals representing the computer program for performing one of the methods described herein. The data stream or the sequence of signals may for example to be transferred via a data communication connection, for example via the Internet.

A further example comprises a processing means, for example a computer, or a programmable logic device, to perform one of the methods described herein.

A further example comprises a computer having installed thereon the computer program for performing one of the methods described herein.

A further example comprises an apparatus or a system to transfer, for example, electronically or optically, a computer program for performing one of the methods described herein to a receiver. The receiver may, for example, be a computer, a mobile device, a memory device or similar. The apparatus or system may, for example, comprise a file server for transferring the computer program to the receiver.

In some examples, a programmable logic device, for example a field programmable gate array, may be used to perform some or all of the functionalities of the methods described herein. In some examples, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

The above described examples are merely illustrative. It is understood that modifications and variations of the arrangements and the details described herein will be apparent.

The foregoing has described the principles, examples and modes of operation.

However, the teaching herein are not to be construed as being limited to the particular examples described. The above-described examples are to be regarded as illustrative rather than restrictive, and variations may be made in those examples without departing from the scope of the following claims.

1. An apparatus, being a network entity of a computer network, wherein the apparatus comprises:
a communication module to receive and to send information on a blockchain,
a query module to:
obtain from a master chain of the blockchain a rule for a first shard and a second shard of the blockchain with respect to a smart contract,
obtain information on the smart contract from the first shard or from the second shard depending on the rule, and
output the information on the smart contract.

2. The apparatus of claim 1,
wherein the rule is a priority order,
wherein the query module is to:
obtain from the master chain of the blockchain the priority order, and
obtain the information on the smart contract from the first shard or from the second shard depending on the priority order.

3. The apparatus of claim 2,
wherein the query module is to:
determine a higher-priority shard and a lower-priority shard for the smart contract, the higher-priority shard being the shard that has a higher priority among the first shard and the second shard with respect to the smart contract, the lower-priority shard being the shard that has a lower priority among the first shard and the second shard with respect to the smart contract,
obtain the information on the smart contract from the higher-priority shard, if the higher-priority comprises the information on the smart contract,
obtain the information on the smart contract from the lower-priority shard, if the higher-priority does not comprise the information on the smart contract.

4. The apparatus of claim 2,
wherein the apparatus further comprises a master chain generator to generate the master chain of the blockchain, so that the master chain comprises for the smart contract the priority order for the first shard and the second shard of the blockchain with respect to the smart contract.

5. The apparatus of claim 4,
wherein the smart contract is one of a plurality of smart contracts,
wherein the master chain generator is to generate the master chain of the blockchain, so that the master chain comprises for each smart contract of the plurality of smart contracts a priority order for the first shard and the second shard of the blockchain.

6. The apparatus of claim 5,
wherein the master chain generator is to generate the master chain in response to the master chain generator detecting that the first shard is different from the second shard.

7. The apparatus of claim 6,
wherein the master chain generator is to detect that the first shard is different from the second shard, in response to the first shard comprising a particular smart contract of the plurality of smart contracts and the second shard does not comprise the particular smart contract, or in response to the second shard comprising the particular smart contract of the plurality of smart contracts and the first shard does not comprise the particular smart contract, or
wherein the master chain generator is to detect that the first shard is different from the second shard in response to first information of a considered smart contract of the plurality of smart contracts within the first shard being different from second information of the considered smart contract within the second shard.

8. The apparatus of claim 2,
wherein the apparatus further comprises a memory having stored therein a local copy of the master chain and a local copy of the first shard and a local copy of the second shard, or
wherein the apparatus further comprises a memory having stored therein a local copy of the master chain but not and a local copy of the first shard and not a local copy of the second shard.

9. The apparatus of claim 2,
wherein the query module is to:
obtain from the master chain of the blockchain the priority order for the first shard, the second shard and a third shard of the blockchain with respect to the smart contract,
obtain information on the smart contract from the first shard or from the second shard or from the third shard depending on the priority order, and
output the information on the smart contract.

10. The apparatus of claim 1,
wherein a plurality of shards of the blockchain comprises the first shard, the second shard and a third shard of the blockchain,
wherein the rule is a majority decision,
wherein the query module is to:
obtain from the master chain of the blockchain an indication to obtain the information with respect to the smart contract depending on the majority decision,
obtain the information on the smart contract from the plurality of shards of the blockchain by determining a majority of the plurality of shards that have same information with respect to the smart contract.

11. The apparatus of claim 1 being a first network entity,
wherein the apparatus of claim 1 and a second network entity are connected by the computer network,
wherein the apparatus comprises a memory having stored thereon the first shard,
wherein the communication module is to receive the second shard from the second network entity,
wherein the apparatus is to store the second shard in the memory.

12. A system comprising:
The apparatus of claim 1 being a first network entity, and
a second network entity,
wherein the apparatus of claim 1 and the second network entity are connected by the computer network,
wherein the apparatus of claim 1 comprises a memory having stored thereon the first shard,
wherein the communication module of the apparatus of claim 1 is to receive the second shard from the second network entity,
wherein the apparatus according to claim 1 is to store the second shard in the memory.

13. A system comprising:
Two apparatuses according to claim 1 being a first network entity and a second network entity,
wherein the two apparatuses according to claim 1 are connected by the computer network,
wherein the first network entity comprises a memory having stored thereon the first shard,
wherein the communication module of the second network entity is to transmit the second shard to the first network entity,
wherein the communication module of the first network entity is to receive the second shard from the second network entity,
wherein the first network entity is to store the second shard in the memory.

14. A method, comprising:
receiving information on a blockchain,
sending information on the blockchain,
obtaining from a master chain of the blockchain a rule for a first shard and a second shard of the blockchain with respect to a smart contract,
obtaining information on the smart contract from the first shard or from the second shard depending on the rule, and outputting the information on the smart contract.

15. A non-transitory computer-readable medium comprising a computer program, wherein the computer program, when executed on a computer or signal processor, causes the computer or signal processor to:
receiving information on a blockchain,
sending information on the blockchain,
obtaining from a master chain of the blockchain a rule for a first shard and a second shard of the blockchain with respect to a smart contract,
obtaining information on the smart contract from the first shard or from the second shard depending on the rule, and outputting the information on the smart contract.
